(19) United States
(12) Patent Application Publication
(10) Pub. No.: US 2022/0184708 A1
(43) Pub. Date: Jun. 16, 2022

(54) BUILDING AN OBJECT WITH A THREE-DIMENSIONAL PRINTER USING BURST MODE JETTING

(71) Applicant: XEROX CORPORATION, Norwalk, CT (US)

(72) Inventors: Denis Cormier, Pittsford, NY (US); Usama Abdullah Rifat, Rochester, NY (US); Paarth Mehta, Rochester, NY (US)

(73) Assignee: XEROX CORPORATION, NORWALK, CT (US)

(21) Appl. No.: 17/121,197

(22) Filed: Dec. 14, 2020

(51) Int. Cl. B22F 10/85; B29C 64/393; B29C 64/112; B29C 64/343; B22F 10/322; B22F 12/57

(52) U.S. Cl. CPC B22F 10/85; B29C 64/393; B29C 64/112; B33Y 10/00; B22F 10/322; B22F 12/57; B29C 64/343

(57) ABSTRACT

A three-dimensional (3D) printer includes an ejector and a coil wrapped at least partially around the ejector. The 3D printer also includes a power source configured to transmit voltage pulses to the coil. The 3D printer also includes a computing system configured to cause the power source to transmit the voltage pulses to the coil in intermittent bursts. The voltage pulses in each burst occur at a burst frequency from about 60 Hz to about 2000 Hz. The coil causes a drop of printing material to be jetted through a nozzle of the ejector in response to each voltage pulse. The drops generated in response to the voltage pulses in each burst land at substantially a same location in a horizontal plane.

### TECHNICAL FIELD

The present teachings relate generally to three-dimensional (3D) printing and, more particularly, to systems and methods for building (e.g., printing) an object with a 3D printer using burst mode jetting.

### BACKGROUND

A 3D printer builds (e.g., prints) a 3D object from a computer-aided design (CAD) model, usually by successively depositing material layer upon layer. For example, a first layer may be deposited upon a substrate, and then a second layer may be deposited upon the first layer. One particular type of 3D printer is a magnetohydrodynamic (MHD) printer, which is suitable for jetting liquid metal layer upon layer to form a 3D metallic object. Magnetohydrodynamic refers to the study of the magnetic properties and the behavior of electrically conducting fluids.

An MHD printer causes an electrical current to flow through a metal coil, which produces time-varying magnetic fields that induce eddy currents within a reservoir of liquid metal compositions. Coupling between magnetic and electric fields within the liquid metal results in Lorentz forces that cause ejection of drops of the liquid metal through a nozzle of the printer. The nozzle may be controlled to select the size and shape of the drops. The drops land upon the substrate and/or the previously deposited drops to cause the object to grow in size. However, objects produced in this manner oftentimes have rough surfaces, which leads to structural weakness.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A three-dimensional (3D) printer is disclosed. The 3D printer includes an ejector and a coil wrapped at least partially around the ejector. The 3D printer also includes a power source configured to transmit voltage pulses to the coil. The 3D printer also includes a computing system configured to cause the power source to transmit the voltage pulses to the coil in intermittent bursts. The voltage pulses in each burst occur at a burst frequency from about 60 Hz to about 2000 Hz. The coil causes a drop of printing material to be jetted through a nozzle of the ejector in response to each voltage pulse. The drops generated in response to the voltage pulses in each burst land at substantially a same location in a horizontal plane.

A method for printing a three-dimensional (3D) object using a 3D printer is also disclosed. The method includes jetting a first burst of drops of a printing material through a nozzle at a burst frequency. The burst frequency is from about 60 Hz to about 2000 Hz. The first burst of drops lands at substantially a same location on a substrate. The method also includes ceasing to jet the drops of the printing material for a pause duration after the first burst of drops is jetted. The method also includes jetting a second burst of drops of the printing material through the nozzle at the burst frequency after the pause duration.

In another embodiment, the method includes jetting a first burst of drops of a liquid metal through a nozzle at a burst frequency. The first burst of drops includes at least a first drop and a second drop. The first drop lands on a substrate. The second drop lands at substantially a same location as the first drop while the first drop is partially or fully in a liquid state. The burst frequency is from about 60 Hz to about 2000 Hz. The first burst of drops includes from 2 drops to 50 drops. The method also includes ceasing to jet the drops of the liquid metal for a pause duration after the first burst of drops is jetted. The first burst of drops partially or fully solidifies on the substrate to form a first layer during the pause duration. The pause duration is from about 500 μs to about 1 s. The method also includes jetting a second burst of drops of the liquid metal through the nozzle at the burst frequency and for the burst duration after the pause duration.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 depicts a schematic cross-sectional view of a 3D printer (e.g., a MHD printer and/or multi-jet printer), according to an embodiment.

FIG. 2 illustrates a schematic side view of a first example of the 3D object on the substrate, according to an embodiment.

FIG. 3 illustrates a photograph of the first example of the 3D object from FIG. 2, according to an embodiment.

FIGS. 4A-4C illustrate schematic side views of a second example of the 3D object on the substrate that is formed when the 3D printer operates in a burst mode, according to an embodiment.

FIG. 5 illustrates a photograph of the second example of the 3D object from FIG. 4, according to an embodiment.

FIG. 6 illustrates a flowchart of a method for printing the object using the 3D printer, according to an embodiment.

FIG. 7 illustrates a graph showing the voltage pulses (and the corresponding jetted drops) versus time, according to an embodiment.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

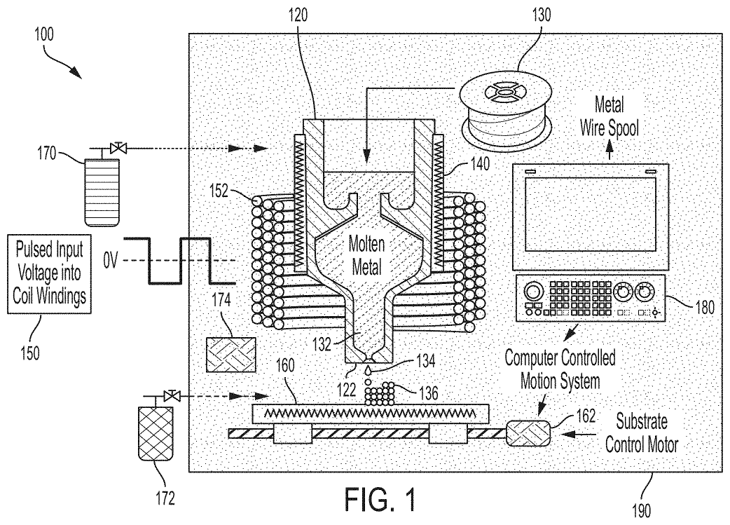

FIG. 1 depicts a schematic cross-sectional view of a 3D printer 100, according to an embodiment. The 3D printer 100 may include an ejector (also referred to as a body or pump chamber) 120. The ejector 120 may define an inner volume (also referred to as a cavity). A printing material 130 may be introduced into the inner volume of the ejector 120. The printing material 130 may be or include a metal, a polymer, or the like. For example, the printing material 130 may be or include aluminum or aluminum alloy (e.g., a spool of aluminum wire).

The 3D printer 100 may also include one or more heating elements 140. The heating elements 140 are configured to melt the printing material 130, thereby converting the printing material 130 from a solid state to a liquid state (e.g., liquid metal 132) within the inner volume of the ejector 120.

The 3D printer 100 may also include a power source 150 and one or more metallic coils 152 that are wrapped at least partially around the ejector 120. The power source 150 may be coupled to the coils 152 and configured to provide an electrical current to the coils 152. In one embodiment, the power source 150 may be configured to provide a step function direct current (DC) voltage profile (e.g., voltage pulses) to the coils 152, which may create an increasing magnetic field. The increasing magnetic field may cause an electromotive force within the ejector 120, that in turn causes an induced electrical current in the liquid metal 132. The magnetic field and the induced electrical current in the liquid metal 132 may create a radially inward force on the liquid metal 132, known as a Lorenz force. The Lorenz force creates a pressure at an inlet of a nozzle 122 of the ejector 120. The pressure causes the liquid metal 132 to be jetted through the nozzle 122 in the form of one or more liquid drops 134.

The 3D printer 100 may also include a substrate 160 that is positioned proximate to (e.g., below) the nozzle 122. The drops 134 may land on the substrate 160 and solidify to produce a 3D object 136. In one example, the 3D object 136 may be or include a strut (also referred to herein as a beam), which may be part of a lattice structure.

The 3D printer 100 may also include a substrate control motor 162 that is configured to move the substrate 160 while the drops 134 are being jetted through the nozzle 122, or during pauses between when the drops 134 are being jetted through the nozzle 122, to cause the 3D object 136 to have the desired shape and size. The substrate control motor 162 may be configured to move the substrate 160 in one dimension (e.g., along an X axis), in two dimensions (e.g., along the X axis and a Y axis), or in three dimensions (e.g., along the X axis, the Y axis, and a Z axis). In another embodiment, the ejector 120 and/or the nozzle 122 may be also or instead be configured to move in one, two, or three dimensions. In other words, the substrate 160 may be moved under a stationary nozzle 122, or the nozzle 122 may be moved above a stationary substrate 160. In yet another embodiment, there may be relative rotation between the nozzle 122 and the substrate 160 around one or two additional axes, such that there is four or five axis position control.

The 3D printer 100 may also include one or more gas-controlling devices, which may be or include gas sources (two are shown: 170, 172). The first gas source 170 may be configured to introduce a first gas. The first gas may be or include an inert gas, such as helium, neon, argon, krypton, and/or xenon. In another embodiment, the first gas may be or include nitrogen. The first gas may include less than about 10% oxygen, less than about 5% oxygen, or less than about 1% oxygen.

In at least one embodiment, the first gas may be introduced at a location that is above where the second gas is introduced. For example, the first gas may be introduced at a location that is above the nozzle 122 and/or the coils 152. This may allow the first gas (e.g., argon) to form a shroud/sheath around the nozzle 122, the drops 134, the 3D object 136, and/or the substrate 160 to reduce/prevent the formation of oxide (e.g., aluminum oxide). Controlling the temperature of the first gas may also or instead help to control (e.g., minimize) the rate that the oxide formation.

The second gas source 172 may be configured to introduce a second gas. The second gas may be different than the first gas. The second gas may be or include oxygen, water vapor, carbon dioxide, nitrous oxide, ozone, methanol, ethanol, propanol, or a combination thereof. The second gas may include less than about 10% inert gas and/or nitrogen, less than about 5% inert gas and/or nitrogen, or less than about 1% inert gas and/or nitrogen. The second gas may be introduced at a location that is below the nozzle 122 and/or the coils 152. For example, the second gas may be introduced at a level that is between the nozzle 122 and the substrate 160. The second gas may be directed toward the nozzle 122, the falling drops 134, the 3D object 136, the substrate 160, or a combination thereof. This may help to control the properties (e.g., contact angle, flow, coalescence, and/or solidification) of the drops 134 and/or the 3D object 136.

The 3D printer 100 may also include another gas-controlling device, which may be or include a gas sensor 174. The gas sensor 174 may be configured to measure a concentration of the first gas, the second gas, or both. More particularly, the gas sensor 174 may be configured to measure the concentration proximate to the nozzle 122, the falling drops 134, the 3D object 136, the substrate 160, or a combination thereof. As used herein, “proximate to” refers to within about 10 cm, within about 5 cm, or within about 1 cm.

The 3D printer 100 may also include a computing system 180. The computing system 180 may be configured to control the printing of the 3D object 136. More particularly, the computing system 180 may be configured to control the introduction of the printing material 130 into the ejector 120, the heating elements 140, the power source 150, the substrate control motor 162, the first gas source 170, the second gas source 172, the gas sensor 174, or a combination thereof. As discussed in greater detail below, in one embodiment, the computing system 180 may control the rate at which the voltage pulses are provided from the power source 150 to the coils 152, and thus the corresponding rate at which the drops 134 are jetted through the nozzle 122. These two rates may be substantially the same.

In another embodiment, the computing system 180 may be configured to receive the measurements from the gas sensor 174, and also configured to control the first gas source 170 and/or the second gas source 172, based at least partially upon the measurements from the gas sensor 174, to obtain the desired gas concentration around the drops 134 and/or the object 136. In at least one embodiment, the concentration of the first gas (e.g., nitrogen) may be maintained between about 65% and about 99.999%, between about 65% and about 75%, between about 75% and about 85%, between about 85% and about 95%, or between about 95% and about 99.999%. In at least one embodiment, the concentration of the second gas (e.g., oxygen) may be maintained between about 0.000006% and about 35%, between about 0.000006% and about 0.00001%, between about 0.00001% and about 0.0001%, between about 0.0001% and about 0.001%, between about 0.001% and about 0.01%, between about 0.01% and about 0.1%, between about 0.1% and about 1%, between about 1% and about 10%, or between about 10% and about 35%.

The 3D printer 100 may also include an enclosure 190 that defines an inner volume (also referred to as an atmosphere). In one embodiment, the enclosure 110 may be hermetically sealed. In another embodiment, the enclosure 110 may not be hermetically sealed. In one embodiment, the ejector 120, the heating elements 140, the power source 150, the coils 152, the substrate 160, the computing system 170, the first gas source 180, the second gas source 182, the gas sensor 184, or a combination thereof may be positioned at least partially within the enclosure 190. In another embodiment, the ejector 120, the heating elements 140, the power source 150, the coils 152, the substrate 160, the computing system 170, the first gas source 180, the second gas source 182, the gas sensor 184, or a combination thereof may be positioned at least partially outside of the enclosure 190.

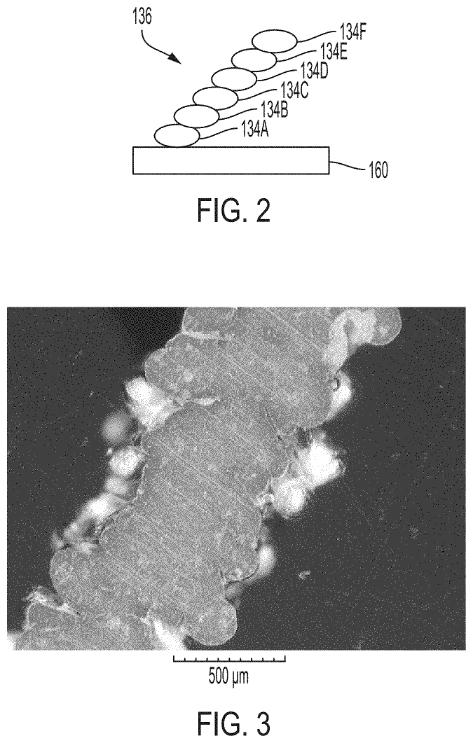

FIG. 2 illustrates a schematic side view of a first example of the 3D object 136 on the substrate 160 that is formed when the 3D printer 100 operates in a non-burst mode, according to an embodiment. To form the 3D object 136, the power source 150 may transmit a plurality of voltage pulses to the coils 152, which may cause a corresponding plurality of drops (six are shown: 134A-134F) to jet through the nozzle 122. The drops 134A-134F may be jetted at a predetermined frequency that allows each drop (e.g., drop 134A) to cool and at least partially (or fully) solidify before the next drop (e.g., drop 134B) is jetted through the nozzle 122 and deposited on the previous drop 134A or the substrate 160. The predetermined frequency may be from about 10 Hz to about 50 Hz, which may cause from about 10 drops to about 50 drops to be jetted through the nozzle 122 per second. Forming the 3D object 136 in this manner may cause the 3D object 136 to be bumpy (e.g., not smooth), as shown in FIG. 3.

In the embodiment shown, the first drop 134A may be deposited onto the substrate 160, the second drop 134B may be deposited onto the first drop 134A, and so on. The drops 134B-134F may not be in contact with the substrate 160. The drops 134A-134F may be jetted such that each drop (e.g., drop 134B) is horizontally offset from the previously jetted drop (e.g., drop 134A) by less than a width of the previously jetted drop (e.g., drop 134A). This may result in the 3D object 136 being oriented at an angle with respect to the substrate 160. As shown, the angle is from about 20° to about 70° or from about 30° to about 60° (e.g., about 45°). In another embodiment, the drops 134A-134F may be stacked directly on top of one another such that the 3D object 136 is substantially vertical and/or perpendicular to the substrate 160. In yet another embodiment, the drops 134A-134F may each be in contact with the substrate 160 such that the 3D object 136 is substantially horizontal and/or parallel to the substrate 160.

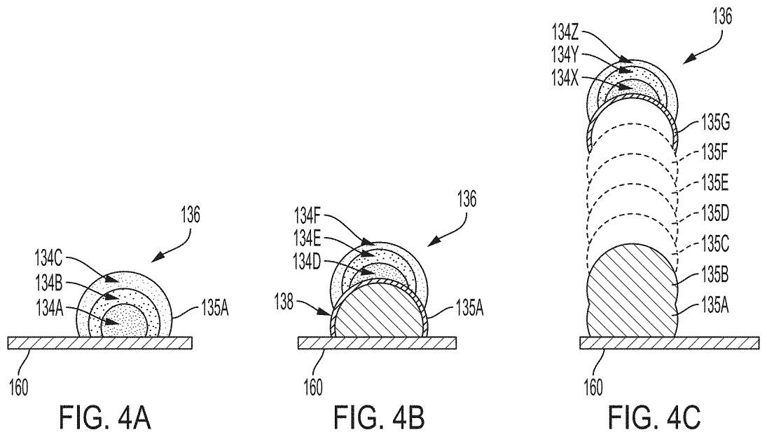

FIGS. 4A-4C illustrate schematic side views of a second example of the 3D object 136 on the substrate 160 that is formed when the 3D printer 100 operates in a burst mode, according to an embodiment. To form the 3D object 136 in the burst mode, the power source 150 may transmit a burst of voltage pulses to the coils 152, which may cause a corresponding burst of drops to jet through the nozzle 122. As used herein, a “burst” refers to a plurality of voltage pulses and/or drops. For example, a burst may include from 2 to 3 voltage pulses and/or drops, from 3 to 5 voltage pulses and/or drops, from 5 to 10 voltage pulses and/or drops, from 10 to 20 voltage pulses and/or drops, or more. As discussed in greater detail below, the frequency at which the drops are jetted in the burst mode (e.g., in FIGS. 4A-4C) is greater than the frequency at which the drops are jetted when not in the burst mode (e.g., in FIG. 2).

As shown in FIG. 4A, a first burst of drops (three are shown: 134A-134C) may be jetted through the nozzle 122 to form a first layer (also referred to herein as a semispherical volume of material) 135A on the substrate 160. The term semispherical volume of material may be used because each burst of drops may land at essentially the same location to form a semispherical volume. As used herein, two drops are in the “same location” when their relative positions (e.g., centers) are within 100 μm, within 10 μm, or within 1 μm from one another. For example, the drops may be about 500 μm in diameter, and the drops may be in the same location when the offset distance between the drops is about 10 μm or less. In another embodiment, two drops may be in the same location when their relative positions (e.g., centers) deviate by less than about 50%, less than about 30%, or less than about 10% of the diameters of the drops. The same location may be in a same horizontal plane (e.g., on the substrate 160).

The first burst of drops 134A-134C may be jetted at a predetermined burst frequency and for a predetermined duration that substantially prevents each drop (e.g., drop 134A) in a particular layer (e.g., layer 135A) from cooling and fully solidifying before the next drop (e.g., drop 134B) in that layer 135A is jetted through the nozzle 122 and/or deposited on the previous drop (e.g., drop 134A). This may allow the second drop 134B to contact and/or at least partially combine with the first drop 134A while the first drop 134A is still partially or fully in a liquid state. Similarly, the third drop 134C may contact and/or at least partially combine with the first and/or second drops 134A, 134B while the first and/or second drops 134A, 134B are still partially or fully in the liquid state. As a result, the drops 134A-134C may form a puddle of liquid metal, which may subsequently solidify to form the first layer 135A.

The burst frequency may be from about 20 Hz to about 50 Hz, about 50 Hz to about 100 Hz, about 100 Hz to about 200 Hz, about 200 Hz to about 500 Hz, about 500 Hz to about 1000 Hz, about 1000 Hz to about 2000 Hz, or greater. The burst frequency may be selected/varied based at least partially upon the volume and/or mass of each drop 134A-134C. For example, as the size of the drops 134A-134C decreases, the frequency may increase so that the drops 134A-134C may contact one another in the fully or partially liquid state to form the puddle before solidifying. Conversely, as the size of the drops 134A-134C increases, the frequency may decrease. Each burst of drops (e.g., the first burst of drops 134A-134C) may have a burst duration from about 500 microseconds (μs) to about 1 ms, about 1 ms to about 5 ms, about 5 ms to about 10 ms, about 10 ms to about 50 ms, about 50 ms to about 100 ms, about 100 ms to about 500 ms, about 500 ms to about 1 second, or longer. The number of drops 134A-134C jetted during each burst and/or burst duration may be from 2 to 50, from 3 to 40, from 4 to 30, or from 5 to 20.

After the first burst of drops 134A-134C has been jetted, the 3D printer 100 may pause (e.g., no drops may be jetted) for a predetermined pause duration to allow the first layer 135A to at least partially (or fully) solidify. The pause duration may be from about 500 microseconds (μs) to about 1 ms, about 1 ms to about 5 ms, about 5 ms to about 10 ms, about 10 ms to about 50 ms, about 50 ms to about 100 ms, about 100 ms to about 500 ms, about 500 ms to about 1 second, or longer.

After the pause, the 3D printer 100 may then jet a second burst of drops (three are shown: 134D-134F) at a desired burst frequency and for the burst duration onto the first layer 135A. The frequency and number of drops in each burst may or may not be identical. This is shown in FIG. 4B. The second burst of drops 134D-134F may be jetted at the predetermined burst frequency to substantially prevent each drop (e.g., drop 134D) in a particular layer (e.g., layer 135B) from cooling and solidifying before the next drop (e.g., drop 134E) in that layer 135B is jetted through the nozzle 122 and/or deposited on the previous drop (e.g., drop 134D). This may allow the second drop 134E to contact and/or at least partially combine with the first drop 134D while the first drop 134D is still partially or fully in a liquid state. Similarly, the third drop 134F may contact and/or at least partially combine with the first and/or second drops 134D, 134E while the first and/or second drops 134D, 134E are still partially or fully in the liquid state. As a result, the drops 134D-134F may form a puddle of fully or partially liquid metal, which may subsequently solidify to form the second layer 135B.

The second burst of drops 134D-134F (i.e., the second layer 135B) may at least partially re-melt the previously deposited layer (e.g., layer 135A). For example, the second burst of drops 134D-134F (i.e., the second layer 135B) may have enough heat to at least partially re-melt and combine with an upper portion (e.g., the top surface) 138 of the previously deposited layer 135A without causing the 3D object 136 to slump over or otherwise distort from the desired shape and/or angle. The upper portion 138 that is re-melted may have a thickness from about 5 μm to about 50 μm.

After the second burst of drops 134D-134F has been jetted, the 3D printer 100 may pause (e.g., no drops may be jetted) for the pause duration to allow the second layer 135B to at least partially (or fully) solidify. Then, the process may repeat to form a plurality of additional layers 135C-135G, as shown in FIG. 4C.

In the embodiment shown, the first burst of drops 134A-134C (i.e., the first layer 135A) may be deposited onto the substrate 160, the second burst of drops 134D-134F (i.e., the second layer 135B) may be deposited onto the first layer 135A, and so on. Thus, the layers 135A-135G may be formed at the same location with no (or minimal) lateral offset, and only vertical offsets. For example, the nozzle 122 may only be moved vertically, but not laterally, during each burst and/or during each pause. As a result, the printer 100 may be configured to jet bursts of drops at the same location at a frequency sufficient to produce a liquid puddle from the multiple drops.

In another embodiment, the layers 135A-135G may be formed such that each layer (e.g., layer 135B) is horizontally offset from the previously deposited layer (e.g., layer 135A) by less than a width of the previously deposited layer (e.g., layer 135A). This may result in the 3D object 136 being oriented at an angle with respect to the substrate 160. The angle may from about 0° to about 30°, about 30° to about 60°, or about 60° to about 90°. Thus, in one example, the 3D object 136 may be substantially horizontal.

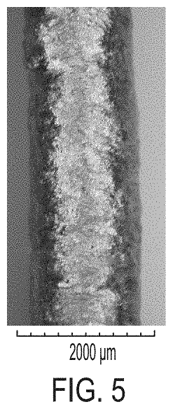

Forming the 3D object 136 using the burst mode may cause the 3D object 136 to be substantially smooth, as shown in FIG. 5, which may improve the mechanical properties of the 3D object 136. In addition, the burst mode may enable the 3D object 136 to have a greater thickness (e.g., diameter) than the printing in the non-burst mode. For example, the 3D object 136 printed using the burst mode may have a thickness from about 1 mm to about 2 mm, about 1 mm to about 2.5 mm, about 1 mm to about 3 mm, about 1 mm to about 4 mm, or about 1 mm to about 5 mm without using a spiral or offset contour printing method.

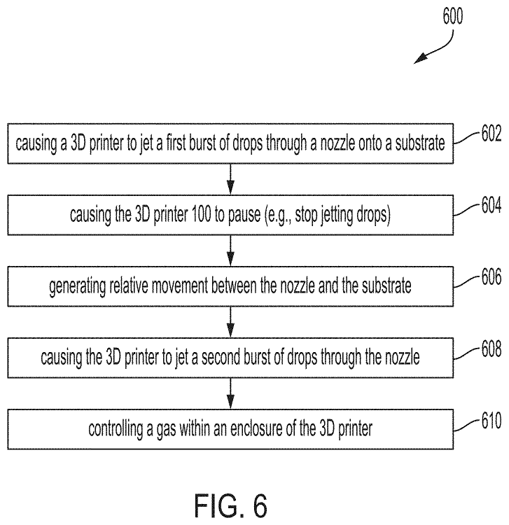

FIG. 6 illustrates a flowchart of a method 600 for printing the 3D object 136 using the 3D printer 100, according to an embodiment. An illustrative order of the method 600 is provided below. One or more steps of the method 600 may be performed in a different order, performed simultaneously, repeated, or omitted.

The method 600 may include jetting the first burst of drops 134A-134C, as at 602. This may include the computing system 180 causing the power source 170 to transmit the first burst of voltage pulses to the coils 152 at the burst mode frequency and for the burst mode duration. In response, the coils 152 may cause the first burst of drops 134A-134C to be jetted through the nozzle 122 at the burst mode frequency, for the burst mode duration, and/or with the desired number of drops in the burst (e.g., from 2 drops to 50 drops). The first burst of drops 134A-134C may be deposited onto the substrate 160. The nozzle 122 and/or the substrate 160 may be/remain substantially stationary (e.g., with respect to one another) during step 602. As mentioned above, each of the drops 134A-134C may be deposited before the other drops 134A-134C in that particular layer 135A fully solidify. For example, the first drop 134A may have a solid volume fraction that is less than about 90%, less than about 70%, less than about 50%, or less than about 30% before the second drop 134B lands on the first drop 134A. If the first drop 134A has a solid volume fraction of 90%, this means that the first drop 134A is 90% solid and 10% liquid.

The method 600 may also include ceasing to jet the drops (e.g., pausing the jetting), as at 604. Step 604 may be performed after step 602. This step may include the computing system 180 causing the power source 150 to stop transmitting the voltage pulses to the coils 152 for the pause duration. In response, the coils 152 may stop causing the drops to be jetted through the nozzle 122. The first burst of drops 134A-134C may cool and at least partially (or fully) solidify during the predetermined pause duration.

The method 600 may also include generating relative movement between the nozzle 122 and the substrate 160, as at 606. Step 606 may be performed before, simultaneously with, or after step 602 and/or 604. This step may include the computing system 180 causing the substrate control motor 162 to move the substrate 160 in one or more dimensions so that the drops 134D-134F land in the desired location(s) to form the 3D object 136. In one example, a (e.g., vertical) distance between the nozzle 122 and the substrate 160 may be increased. In another example, lateral (e.g., horizontal) movement between the nozzle 122 and the substrate 160 may be introduced so that the layers 135A, 135B are laterally offset from one another but at least partially overlapping. In yet another example, step 606 may be omitted.

The method 600 may include jetting the second burst of drops 134D-134F, as at 608. Step 608 may be performed before, simultaneously with, or after step 606. This step may include the computing system 180 causing the power source 170 to transmit a second burst of voltage pulses to the coils 152 at the burst frequency and for the burst duration. In response, the coils 152 may cause the second burst of drops 134D-134F to be jetted through the nozzle 122 at the burst frequency, for the burst duration, and/or with the desired number of drops in the burst (e.g., from 2 drops to 50 drops). The second burst of drops 134D-134F may be deposited onto the substrate 160 and/or onto the first burst of drops 134A-134C (e.g., the first layer 135A), as shown in FIGS. 4A-4C. The nozzle 122 and/or the substrate 160 may be/remain substantially stationary (e.g., with respect to one another) during step 608. As mentioned above, each of the drops 134D-134F may be deposited before the other drops 134D-134F in that particular layer 135B fully solidify. In one embodiment, the method 600 may loop back around to step 604 and repeat to form additional layers 135C-135G of the 3D object 136.

The method 600 may also include controlling a gas within the enclosure 110, as at 610. Step 610 may be performed before, simultaneously with, or after step 602, 604, 606, 608, or a combination thereof. This step may include measuring a gas concentration (e.g., of the first gas and/or the second gas) within the enclosure 110 using the gas sensor 174. The gas concentration may then be transmitted from the gas sensor 174 to the computing system 180. The computing system 180 may then maintain or vary the concentration of the gas (e.g., the first gas and/or the second gas) within the enclosure 110 using the gas source(s) 170, 172 based at least partially upon the measured gas concentration.

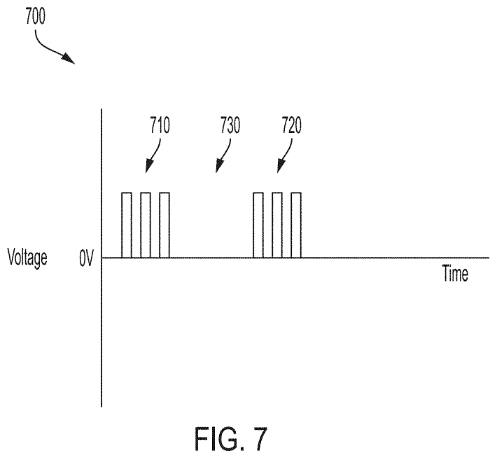

FIG. 7 illustrates a graph 700 showing the voltage pulses (and the corresponding jetted drops) versus time, according to an embodiment. More particularly, the graph 700 shows a first burst of voltage pulses 710 that is at the burst frequency for the burst duration. The first burst of voltage pulses 710 generates the first burst of drops 134A-134C at the burst frequency, for the burst duration, and includes the desired number of drops in the burst. The graph 700 also shows a second burst of voltage pulses 720 that is at the burst frequency for the burst duration. The second burst of voltage pulses 720 generates the first burst of drops 134D-134F at the burst frequency, for the burst duration, and includes the desired number of drops in the burst. The graph 700 also shows a pause 730 between the first and second bursts 710, 720. The pause 730 may have the pause duration described above.

Notwithstanding that the numerical ranges and parameters setting forth the broad scope of the present teachings are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” may include any and all sub-ranges between (and including) the minimum value of zero and the maximum value of 10, that is, any and all sub-ranges having a minimum value of equal to or greater than zero and a maximum value of equal to or less than 10, e.g., 1 to 5.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A three-dimensional (3D) printer, comprising:
an ejector;
a coil wrapped at least partially around the ejector;
a power source configured to transmit voltage pulses to the coil; and
a computing system configured to cause the power source to transmit the voltage pulses to the coil in intermittent bursts, wherein the voltage pulses in each burst occur at a burst frequency from about 60 Hz to about 2000 Hz, wherein the coil causes a drop of printing material to be jetted through a nozzle of the ejector in response to each voltage pulse, and wherein the drops generated in response to the voltage pulses in each burst land at substantially a same location in a horizontal plane.

2. The 3D printer of claim 1, wherein each burst of voltage pulses generates from 2 drops to 50 drops, and wherein the computing system is configured to pause the voltage pulses between each burst for a pause duration that is from about 500 μs to about 1 second.

3. The 3D printer of claim 2, wherein the printing material comprises aluminum, aluminum alloys, or a combination thereof.

4. The 3D printer of claim 2, wherein the printing material comprises metal, metallic alloys, or a combination thereof.

5. The 3D printer of claim 4, further comprising:
a heating element configured to heat the printing material in the ejector, thereby causing the printing material to change from a solid state to a liquid state within the ejector;
a substrate positioned below the nozzle and configured to receive the drops of the printing material after the drops of the printing material are jetted through the nozzle; and
a motor configured to move the substrate, the nozzle, or both relative to one another during a pause between the two of the bursts of the voltage pulses.

6. A method for printing a three-dimensional (3D) object using a 3D printer, the method comprising:
jetting a first burst of drops of a printing material through a nozzle at a burst frequency, wherein the burst frequency is from about 60 Hz to about 2000 Hz, and wherein the first burst of drops lands at substantially a same location on a substrate;
ceasing to jet the drops of the printing material for a pause duration after the first burst of drops is jetted; and
jetting a second burst of drops of the printing material through the nozzle at the burst frequency after the pause duration.

7. The method of claim 6, wherein the burst frequency is from about 100 Hz to about 2000 Hz.

8. The method of claim 6, wherein the first burst of drops comprises a first drop and a second drop, wherein the second drop is jetted through the nozzle after the first drop, and wherein the second drop lands at substantially the same location as the first drop while the first drop is still in a partially liquid state.

9. The method of claim 8, wherein the first drop has a solid volume fraction that is less than about 70% before the second drop lands on the first drop.

10. The method of claim 6, wherein the first and second bursts each include from 2 drops to 50 drops, and wherein the pause duration is from about 500 us to about 1 second.

11. The method of claim 10, wherein the first burst of drops cools and partially or fully solidifies during the pause duration to form a first layer.

12. The method of claim 11, wherein the second burst of drops lands partially or fully on the first layer and at least partially re-melts an outer portion of the first layer.

13. The method of claim 6, wherein the first burst of drops lands on the substrate, wherein the substrate is substantially horizontally stationary with respect to the nozzle while the first burst of drops is jetted through the nozzle, and wherein the method further comprises generating relative movement between the nozzle and the substrate during the pause duration.

14. The method of claim 13, wherein the second burst of drops is jetted through the nozzle after the relative movement is generated such that a location of the second burst of drops is at least partially offset from the first plurality of drops.

15. The method of claim 6, further comprising:
measuring a gas concentration around the nozzle, the first burst or drops, the 3D object, or a combination thereof; and
varying a concentration of the gas using a gas source in response to the measured gas concentration.

16. A method for printing a three-dimensional (3D) object using a 3D printer, the method comprising:
jetting a first burst of drops of a liquid metal through a nozzle at a burst frequency, wherein the first burst of drops comprises at least a first drop and a second drop, wherein the first drop lands on a substrate, wherein the second drop lands at substantially a same location as the first drop while the first drop is partially or fully in a liquid state, wherein the burst frequency is from about 60 Hz to about 2000 Hz, and wherein the first burst of drops includes from 2 drops to 50 drops;
ceasing to jet the drops of the liquid metal for a pause duration after the first burst of drops is jetted, wherein the first burst of drops partially or fully solidifies on the substrate to form a first layer during the pause duration, and wherein the pause duration is from about 500 μs to about 1 s; and
jetting a second burst of drops of the liquid metal through the nozzle at the burst frequency and for the burst duration after the pause duration.

17. The method of claim 16, wherein the nozzle and the substrate are substantially horizontally stationary with respect to one another during the jetting of the first and second bursts of drops.

18. The method of claim 16, wherein the nozzle and the substrate are substantially horizontally stationary with respect to one another during the pause duration.

19. The method of claim 16, wherein the nozzle and the substrate move with respect to one another during the pause duration.

20. The method of claim 16, wherein the second burst of drops solidifies as a second layer on the first layer, and wherein the second layer is at least partially laterally offset from the first layer.
